(19) United States
(12) Patent Application Publication
(10) Pub. No.: US 2011/0093167 A1
(43) Pub. Date: Apr. 21, 2011

(54) Power Steering Systems

(76) Inventors: Connel Brett Williams, Leamington Spa (GB); Jeffrey Ronald Coles, West Midlands (GB)

(21) Appl. No.: 12/086,833

(22) PCT Filed: Dec. 21, 2006
(86) PCT No.: PCT/GB2006/004885

§ 371 Date: May 25, 2010

(30) Foreign Application Priority Data
Dec. 23, 2005 (GB) 0526277.9

(51) Int. Cl. B62D 6/00; B62D 5/06

(52) U.S. Cl. 701/41; 180/421; 180/422; 180/423

(57) ABSTRACT

A power steering system comprises a hydraulic circuit, a pump arranged to pressurize hydraulic fluid and valve means arranged to control the flow of pressurized fluid in the hydraulic circuit to control the steering force provided by the system. The system further comprises a motor arranged to drive the pump and control means arranged to control operation of the motor, and the control means is arranged to determine the position of the motor from a plurality of parameters by means of a position determining algorithm.

### CROSS-REFERENCE TO RELATED APPLICATIONS

This application is the National Stage of International Application No. PCT/GB2006/004885 filed Dec. 21, 2006, the disclosures of which are incorporated herein by reference in their entirety, and which claimed priority to Great Britain Patent Application No. 0526277.9 filed Dec.23, 2005, the disclosures of which are incorporated herein by reference in their entirety.

### BACKGROUND OF THE INVENTION

This invention relates to power steering systems and in particular to the control of electric motors in power steering systems.

Vehicle power steering systems, as with all automotive systems, there is a continual drive to keep costs down whilst maintaining durability and reliability. It is therefore desirable to reduce the number of components in any system, and also to keep computational overheads to a minimum.

### BRIEF SUMMARY OF THE INVENTION

Accordingly the present invention provides a power steering system comprising a hydraulic circuit, a pump arranged to pressurize hydraulic fluid and valve means arranged to control the flow of pressurized fluid in the hydraulic circuit to control the steering force provided by the system, the system further comprising a motor arranged to drive the pump and control means arranged to control operation of the motor, wherein the control means is arranged to determine the position of the motor from a plurality of parameters by means of a position determining algorithm.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a power steering system according to an embodiment of the invention;

FIG. 2 is a graph of the speed control function of an electric motor of the system of FIG. 1;

FIG. 3 is a diagram of an electric motor of the system of FIG. 1;

FIG. 4 is diagram of a drive circuit for the motor of FIG. 3;

FIG. 5 is a diagram showing the different electrical states of the drive circuit of FIG. 3

FIG. 6 is a space vector diagram used to determine the states of the drive circuit which are required to produce a desired motor output;

FIG. 7 shows the components of motor phase voltages in the motor of FIG. 3;

FIG. 8 is a functional block diagram of the motor and control unit of FIG. 1;

FIG. 9 is a functional block diagram of a motor and control unit of a known system using a motor position sensor;

FIG. 10 shows the inputs and outputs of the sensorless algorithm of FIG. 8;

FIG. 11 shows the inputs and outputs of separate parts of the sensorless algorithm of FIG. 10.

### DETAILED DESCRIPTION OF THE INVENTION

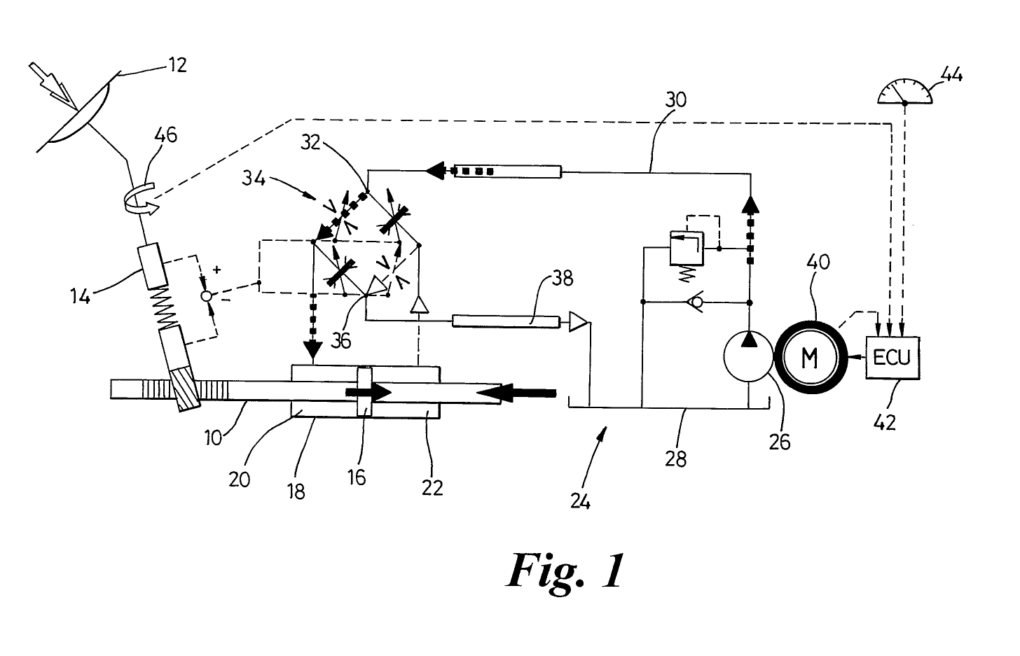

Referring to FIG. 1, an electro-hydraulic power steering system comprises a steering rack 10 arranged to be moved to the left and right to control the steering angle of the front wheels of a vehicle in conventional manner. The rack is moved primarily by driver input to the steering wheel 12 which is connected to the steering rack 10 by a steering column 14. Power assistance is provided by means of a two-sided piston 16 mounted on the steering rack 10 and movable in a cylinder 18. The piston divides the cylinder into two chambers 20, 22. The pressure of hydraulic fluid in the two hydraulic chambers 20, 22 is controlled by a hydraulic circuit 24 to control the direction and magnitude of the power assistance force applied to the steering rack 10.

The hydraulic circuit comprises a pump 26 arranged to pump hydraulic fluid under pressure from a reservoir 28 to a feed line 30. The feed line is connected to an inlet port 32 of a pressure control valve 34, which is represented functionally in FIG. 1. An outlet port 36 of the pressure control valve 34 is connected via a return line 38 to the reservoir 28. The pressure control valve 34 is arranged to connect either the left or right hydraulic chamber 20, 22 to the feed line 30 and the other chamber 20, 22 to the return line depending on which direction steering torque is applied to the steering wheel 12. It is also arranged to control the fluid pressure applied to the hydraulic chambers 20, 22 to control the level of hydraulic power assistance depending on the steering torque being transmitted from the steering wheel 12 to the rack 10 through the steering column 14. The pressure in the hydraulic chambers 20, 22 is clearly determined by the speed of the pump 26 as well as the state of the pressure control valve 34.

The pump 26 is driven by a motor 40 which is controlled by a control unit 42. The control unit 42 receives an input signal from a vehicle speed sensor 44 which is variable with vehicle speed, and an input signal from a steering rate sensor 46 which varies with the steering rate, i.e. the rate of rotation of the steering wheel 12. The control unit 42 controls the speed of the pump 26 on the basis of these inputs. This system is therefore referred to as a speed control system.

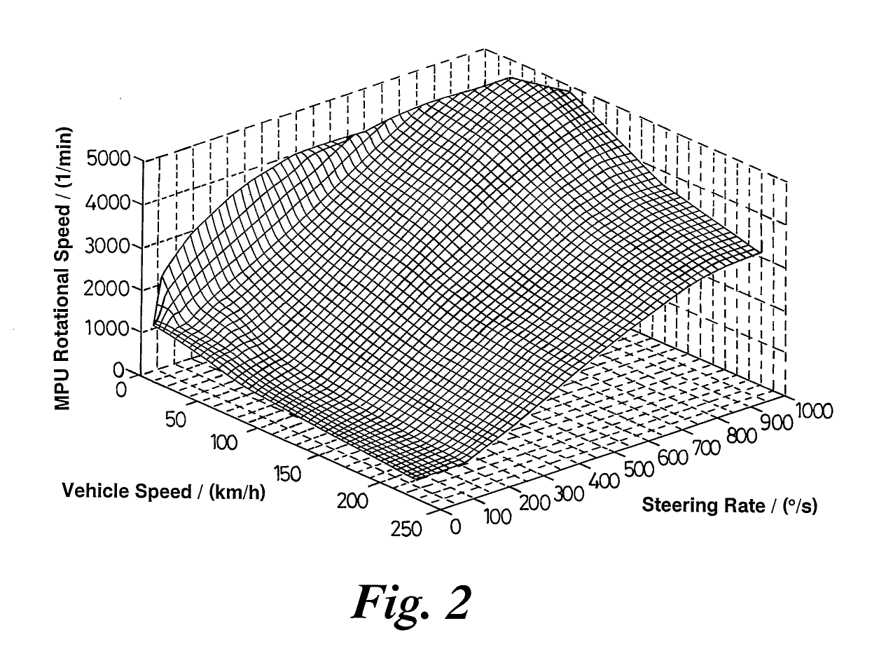

Referring to FIG. 2, the speed of the motor 40, and hence the pump 26, is generally arranged to increase with steering rate, and decrease with increasing vehicle speed.

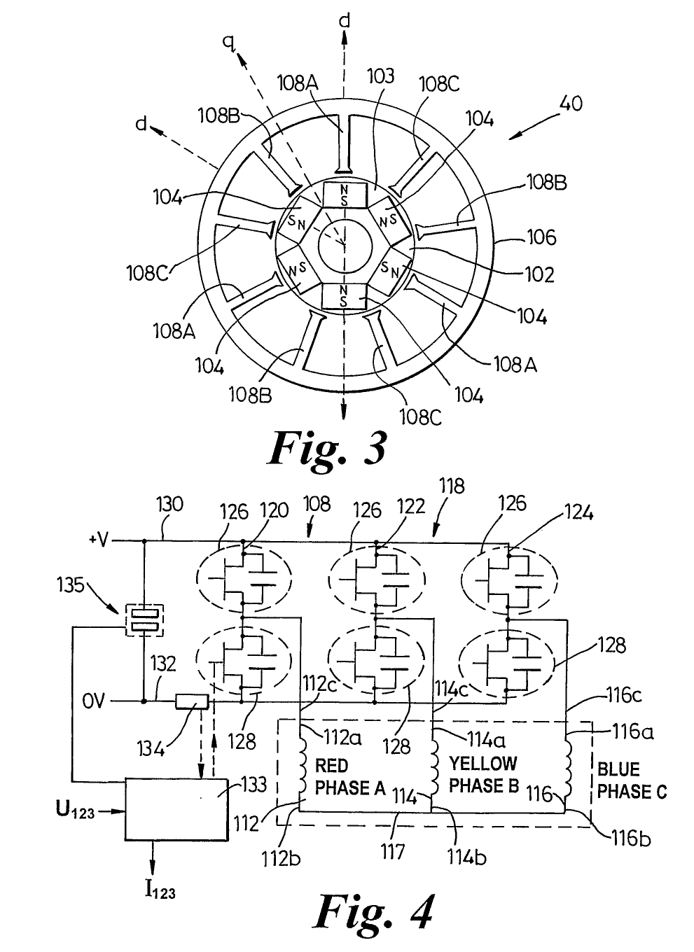

Referring to FIG. 3, the motor 40 is a three phase electrically commutated sinusoidal AC brushless permanent magnet synchronous motor which comprises a rotor 102 having, for example, six magnets 104 mounted on it, which in this instance are arranged so as to provide six poles which alternate between north and south around the rotor. The rotor 102 therefore defines three direct or d axes evenly spaced around the rotor and three quadrature or q axes interspaced between the d axes. The d axes are aligned with the magnetic poles of the magnets 104 where the lines of magnetic flux from the rotor are in the radial direction, and the q axes are spaced between the d axes where the lines of magnetic flux from the rotor are in the tangential direction. As the rotor rotates, the directions of the d and q axes clearly rotate with it.

A stator 106 in this particular embodiment comprises, for example, a nine slot copper wound element having three groups 108A, 108B, 108C of three teeth, each group of teeth having a common winding forming a respective phase. There are therefore three electrical cycles in each full rotation of the rotor, and the three teeth in any phase 108A, 108B, 108C are always in the same electrical position as each other.

Referring to FIG. 4, the three motor windings 112, 114, 116, generally designated as phases A, B and C, are connected in a star network. In other embodiments, other arrangements, such as delta networks, can be used. The phase windings are coiled around the stator teeth 108A, 108B, 108C respectively. One end 112a, 114a, 116a of each coil is connected to a respective terminal 112c, 114c, 116c. The other ends 112b, 114b, 116b, of the coils are connected together to form the star centre 117. A drive circuit comprises a three-phase bridge 118. Each arm 120, 122, 124 of the bridge comprises a pair of switches in the form of a top transistor 126 and a bottom transistor 128 connected in series between a supply rail 130 and ground line 132. A DC link voltage is applied between the supply rail 130 and the ground line 132. The motor windings 112, 114, 116 are each tapped off from between a respective complementary pair of transistors 126, 128. The transistors 126, 128 are turned on and off in a controlled manner by a drive stage controller 133 within the control unit 42 to provide pulse width modulation (PWM) of the potential applied to each of the terminals 112c, 114c, 116c, thereby to control the potential difference applied across each of the windings 112, 114, 116 and hence also the current flowing through the windings. This in turn controls the strength and orientation of the magnetic field produced by the windings, and hence the torque and speed of the motor.

A current measuring device in the form of a resistor 134 is provided in the ground line 132 between the motor 40 and ground so that the controller 42 can measure the total current flowing though all of the windings 112, 114, 116. In order to measure the current in each of the windings the total current has to be sampled at precise instants within the PWM period where the voltage applied to each terminal of the winding (and hence the conduction state of a particular phase) is known. As is well known, in order for the currents in each of the windings to be measured in any one PWM period, the drive circuit needs to be in each of at least two different active states for a predetermined minimum time. The drive stage controller 133 can determine the phase currents from the voltages across the resistor 134 measured at different times in the PWM period.

A DC link voltage sensor 135 is arranged to measure the DC link voltage across the drive circuit, i.e. between the supply rail 130 and the ground line 132. The drive stage controller 133 receives an input from this voltage sensor 135. From this input the controller is arranged to measure the phase voltages in the motor. In order to do this, the controller 133 determines the modulation duty cycle of each motor phase, i.e. the proportion of each PWM period for which the phase is connected to the supply rail, and multiplies this by the measured DC link voltage. This gives a measure of the phase voltage for each phase.

The control unit 42 is arranged to determine the phase voltages of the motor that will produce the required motor currents and to input these voltages to the drive stage controller 133. The drive stage controller 133 is arranged to control the transistors of the drive stage to produce the required phase voltages as will now be described.

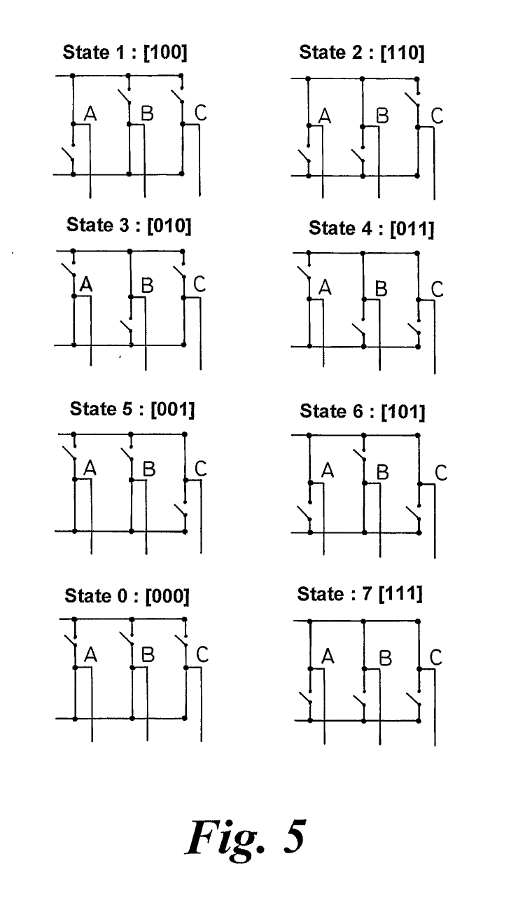

Referring to FIG. 5, each winding 102, 104, 106 in a three-phase system can only be connected to either the supply rail 120 or the ground line 122 and there are therefore eight possible states of the control circuit. Using 1 to represent one of the phases being at positive voltage and 0 to represent a phase connected to ground, state 1 can be represented as indicating phase A at 1, phase B at 0 and phase C at 0, State 2 is represented as [110], state 3 as [010], state 4 as [011], state 5 as [001], state 6 as [101], state 0 as [000] and state 7 as [111]. Each of states 1 to 6 is a conducting state in which current flows through all of the windings 102, 104, 106, flowing in one direction through one of them and in the other direction through the other two. State 0 is a zero volt state in which all of the windings are connected to ground and state 7 is a zero volt state in which all the windings are connected to the supply rail.

States 1, 2, 3, 4, 5 and 6 are herein also referred to as states +A, −C, +B, −A, +C and −B respectively, because they each represent the states in which the voltage applied across the windings is in a positive or negative direction for a respective one of the phases. For example in the +A state the A phase is connected to the supply rail and the other two phases are connected to the ground link, and in the −A state the connections are reversed.

When the circuit is being controlled to produce PWM, each of the phases will normally be turned on and off once in each PWM period. The relative lengths of time that are taken up in each state will determine the magnitude and direction of the magnetic field produced in each winding, and hence the magnitude and direction of the total torque applied to the rotor. These lengths of time, or duty ratios, can be calculated using various modulation algorithms but in this embodiment a space vector modulation technique is used.

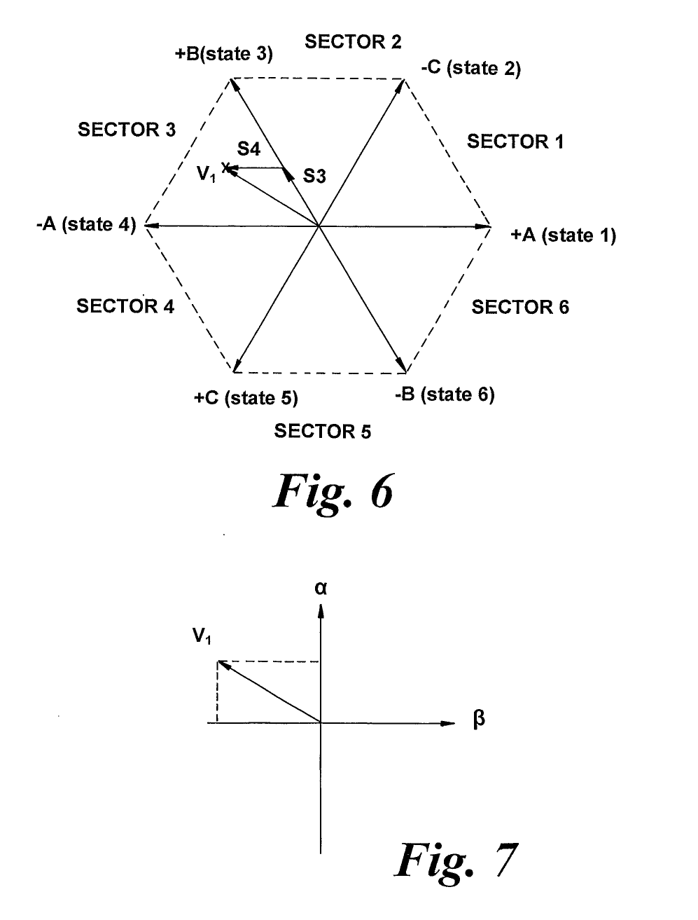

Referring to FIG. 6, in space vector modulation systems, the times in each PWM period spent in each of the states are represented as state vectors in a space vector modulation (SVM) diagram. In this type of diagram, single state vectors are those in the directions of the vectors S1 to S6, and the length of the vectors in each of these directions represents the amount of time in each PWM period spent in the respective state. This means that any desired voltage in the windings can be represented as a point on the diagram which corresponds to a voltage vector which represents the magnitude and direction of the voltage, and can be produced by a combination of state vectors S1, S2, etc. the lengths of which represent the time in each PWM period spent in that state. For example, the desired voltage vector V₁ can be represented as the sum of vectors S3 and S4. As the motor rotates, the direction of the desired vector will change, so the vector will rotate about the centre of the diagram, the length of the vector also changing as the required torque from the motor changes.

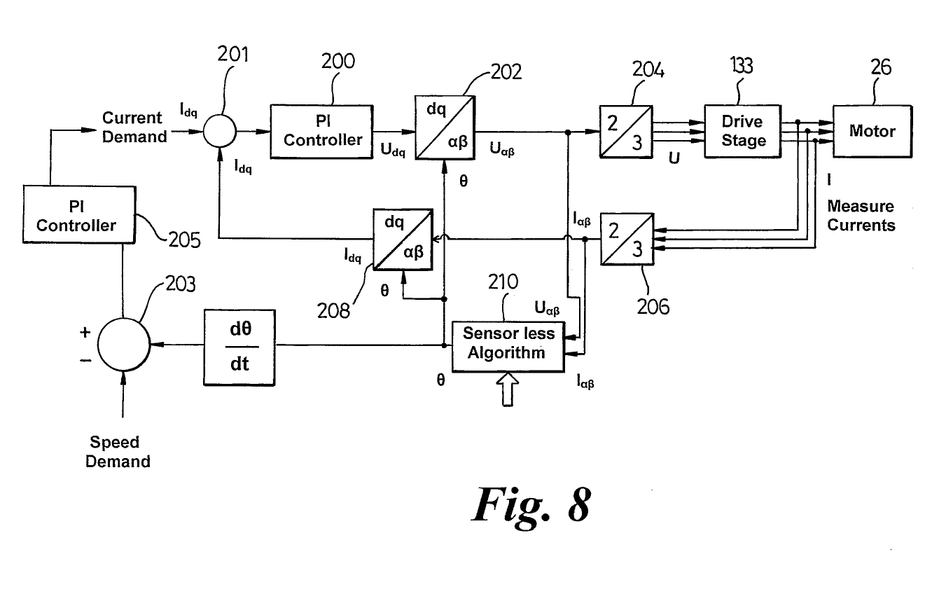

Referring to FIG. 7, the desired voltage from the stator windings can also be expressed in terms of two components, one in each of two orthogonal directions α, β. It will be appreciated from FIG. 3 that the motor goes through three electrical cycles for each complete rotation of the rotor 102. In each electrical cycle the demanded voltage vector will rotate around the state vector diagram once. The directions of the α and β components are therefore spaced apart by the same angle as the d and q axes, with the α and β components defining the voltage vector relative to the stator and the d and q components defining the voltage vector relative to the rotor. Provided the rotor position is know, the voltage as defined in any one of the d/q, α/β or A/B/C components can be converted to any of the others.

Referring to FIG. 8, the operation of the control unit 42 will now be described in more detail. The required rotational speed of the motor, as derived from the plot of FIG. 2, compared to the measured rotational speed by means of a comparator 203. The difference between the two is input to a PI controller 205 which calculates the motor current required to reduce this difference, and outputs a corresponding current demand I_{dq} The demanded current components I_{d\dot{q}} are compared with corresponding measured d and q axis currents, and the difference measured by a comparator 201. Two PI (proportional/integral) controllers 200 (only one of which is shown) are arranged to use the difference between the measured and demanded d and q axis currents to determine the required d and q axis voltages U_{dq}. A dq/αβ converter 202 converts the d and q axis voltages to α and β axis voltages U_{αβ}, using motor position as an input. The motor position is determined using a sensorless algorithm as described below. A further converter 204 converts the α and β axis voltages to desired phase voltages U_{abc} for the three motor phases. These phase voltages are input to the drive stage controller 133 which controls the drive stage 118 as described above to achieve the desired phase voltages.

The three measured phase currents I_{abc}, in this case as measured using the single current sensor 134, are input to a first current converter 206 which converts them to α and β axis currents I_{αβ}. These are then input to a second current converter 208, together with the motor position, and the second current converter 208 converts them to d and q axis currents I_{dq}. These measured d and q axis currents are used for comparison with the demanded d and q axis currents as described above.

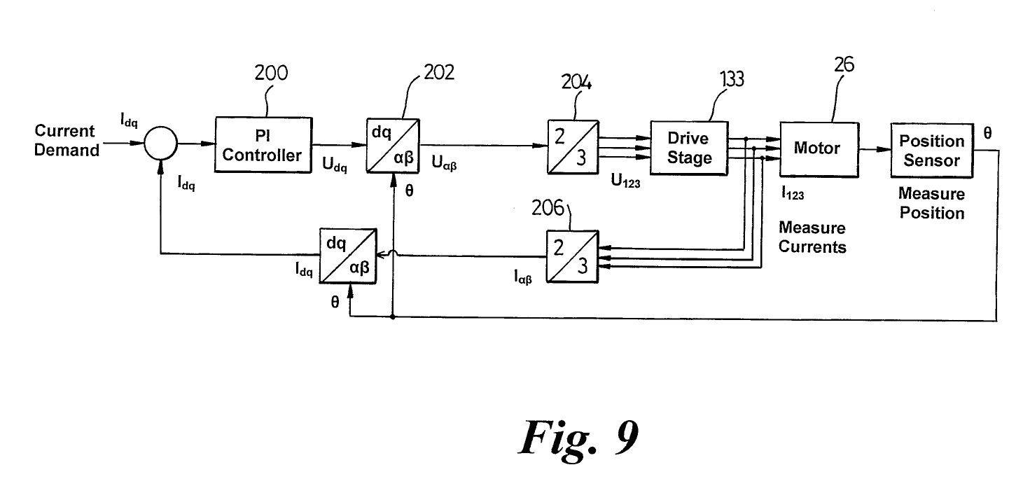

For reference, a system in which a motor position sensor is used instead of the position determining algorithm is shown in FIG. 9.

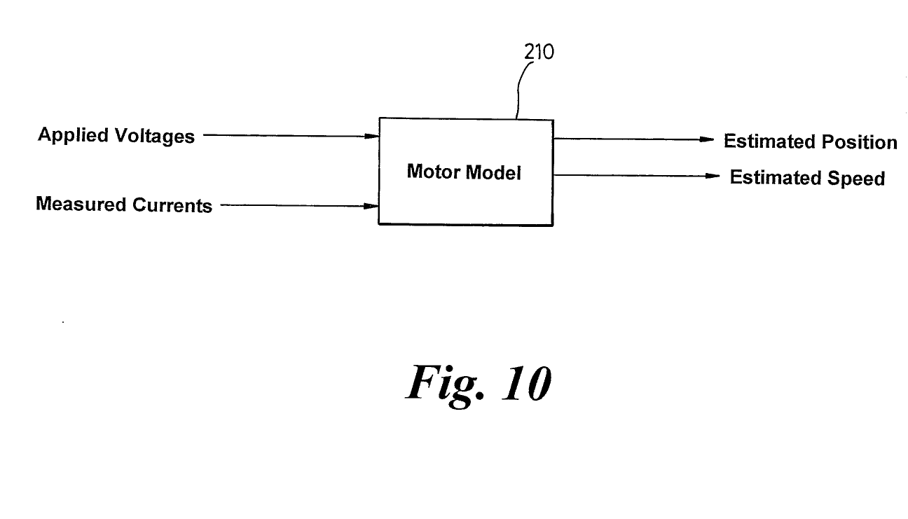

Referring to FIG. 10, a sensorless motor position determining algorithm 210 is arranged to receive as inputs the applied voltages, in this case in the form of α and β axis voltages, and the measured currents, in this case in the form of the α and β axis currents. The sensorless algorithm comprises a model of the motor, and produces from the inputs estimates of motor position and motor speed.

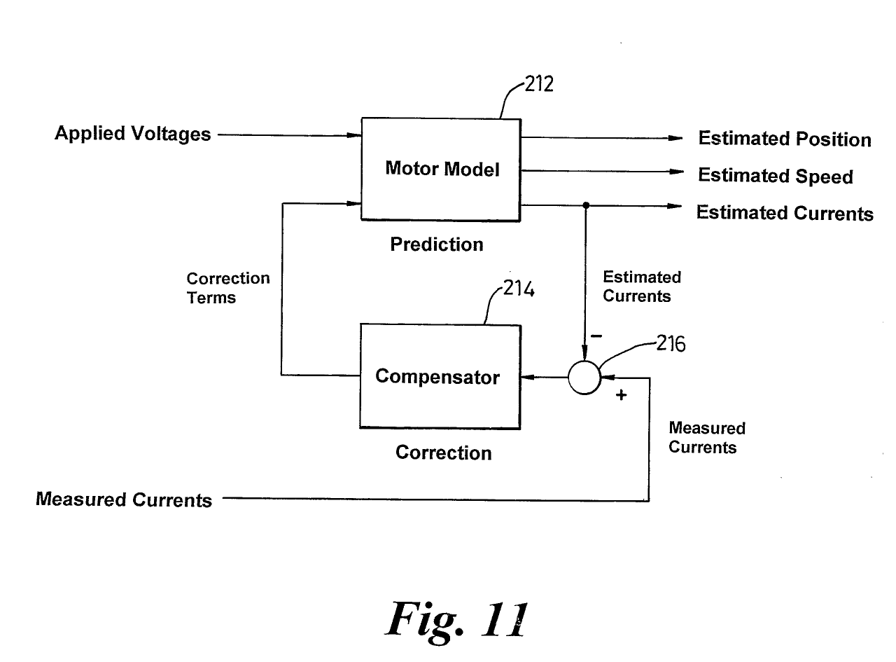

Referring to FIG. 11, the algorithm in this case is a predictor-corrector or observer type algorithm. It includes a predictor 212 and a compensator or observer 214. The predictor 212 includes a model of the motor, and optionally other parts of the system, which includes definitions of its motor electrical parameters, such as resistance and inductance, and also the physical parameters such as inertia and damping. The model is defined as a series of equations, which derive model outputs from model inputs. The model is arranged to receive as inputs the applied voltages. It produces as outputs estimates for various parameters or states of the motor, specifically motor position and motor speed and the currents in the motor. The estimated currents are compared with the measured currents in a comparator 216 and the difference between the two is input as an error or residual signal to the compensator 214. The compensator 214 derives, from the residual, a correction factor for each of the motor states which is arranged to minimize the current residual, and hence to reduce the error in the position estimation. The correction terms output by the compensator 214 are input to the predictor 212 which corrects the states accordingly. The compensator 214 therefore provides a closed loop feedback for the predictor that enables the states, for example the position and speed, defined by model, to be corrected. This makes the sensorless algorithm robust to measurement and model errors.

The following equation represents in general terms the operation of the observer, which in this case is a non-linear observer to accommodate the non-linear terms in the model of the motor. The state estimates (motor phase currents, rotor position and rotor speed) are represented by \hat{x}, and the measured phase voltages by u. The motor and system dynamics are represented by the non-linear functions A and B. The actual states are represented by x, so the residuals are represented by (x−\hat{x}), and the corrector by the non-linear function C.

{dot over (\hat{x}=A\hat{x}+Bu+C(x−\hat{x})

The equations for the non-linear observer in this example are:

$$\begin{matrix}\frac{d {\hat{i}}_{α}}{d t} = - \frac{R}{L} {\hat{i}}_{α} + \frac{{k}_{e} {\hat{ω}}_{m}}{\sqrt{3} L} sin ( {\hat{θ}}_{e} ) + \frac{1}{L} {u}_{α} + {corr}_{α} & ( 1 ) \\ \frac{d {\hat{i}}_{β}}{d t} = - \frac{R}{L} {\hat{i}}_{β} - \frac{{k}_{e} {\hat{ω}}_{m}}{\sqrt{3} L} cos ( {\hat{θ}}_{e} ) + \frac{1}{L} {u}_{β} + {corr}_{β} & ( 2 ) \\ \frac{d {\hat{ω}}_{m}}{d t} = \frac{{k}_{t}}{J} {\hat{i}}_{q} - \frac{B}{J} {\hat{ω}}_{m} + {corr}_{ω} & ( 3 ) \\ \frac{d {\hat{θ}}_{e}}{d t} = p {\hat{ω}}_{m} + {corr}_{θ} & ( 4 )\end{matrix}$$

The following correction terms are used in the observer:

$$\begin{matrix}{corr}_{α} = {g}_{i} ( {i}_{α} - {\hat{i}}_{α} ) & ( 5 ) \\ {corr}_{β} = {g}_{i} ( {i}_{β} - {\hat{i}}_{β} ) & ( 6 ) \\ {corr}_{ω} = - {g}_{ω} \frac{\sqrt{3} L}{{k}_{e}} ( {i}_{q} - {\hat{i}}_{q} ) & ( 7 ) \\ {corr}_{θ} = {g}_{θ} \frac{\sqrt{3} L}{{k}_{e}} \frac{1}{{\hat{ω}}_{m}} ( {i}_{d} - {\hat{i}}_{d} ) \\ where : & ( 8 ) \\ {\hat{i}}_{d} = {\hat{i}}_{α} cos ( {\hat{θ}}_{e} ) + {\hat{i}}_{β} sin ( {\hat{θ}}_{e} ) & ( 9 ) \\ {\hat{i}}_{q} = - {\hat{i}}_{α} sin ( {\hat{θ}}_{e} ) + {\hat{i}}_{β} cos ( {\hat{θ}}_{e} ) & ( 10 )\end{matrix}$$

The terms in these equations are defined as follows:
(α,β)=stator (fixed) reference frame
(d,q)=rotor reference frame
i_{α}, i_{β}=motor currents
u_{α}, u_{β}=motor voltages
θ_{c}=motor electrical angle (radians electrical)
ωₘ=motor mechanical angular velocity (radians mechanical per second)
R=motor phase resistance
L=motor inductance (phase self-inductance plus mutual inductance)
B=motor mechanical viscosity
J=motor mechanical inertia
kₑ=motor back emf constant (as defined below)
kₜ=motor torque constant (as defined below)
p=number of pole pairs for the motor
gᵢ, g_{w}, g_{θ}=observer gains (tuneable parameters)

The motor back-emf and torque constants are defined as follows:
kₑ=peak line-to-line voltage/mechanical angular velocity
kₜ=average motor torque/peak motor current

The symbol ̂ above a quantity indicates that it is an estimated value as opposed to a measured value.

The values for each of the variables are obtained as follows:
i_{α}, i_{β} are derived from the measured phase currents as described above;
u_{α}, u_{β} are derived from the measured phase voltages;
θₑ is the variable being determined from the algorithm;
\hat{ω}ₘ is an internal state of the observer. Externally of the observer, the angular velocity is determined by differentiating the motor position
state θₑ of the observer;
R, L, B, and J are defined as constants;
kₑ and kₜ are defined as indicated above and determined using off-line measurements;
p is the number of motor pole pairs, which is a known constant.

The fact that the controller is arranged to derive the motor speed from the differential of the estimated position has the advantage that, providing the rotor is turning and the system has reached a steady state equilibrium, the accuracy of the speed signal for the speed control of the motor is determined only by the accuracy of the clock of the microprocessor in the controller that is running the algorithm.

It will be appreciated that the position determining algorithm described above will not work from zero speed, as the correction term for the position θ includes the angular velocity w in the denominator. The speed of the motor at low speeds is therefore controlled in an open loop manner with no measurement or estimate of motor position. In this low speed mode, the control unit 42 is arranged to simply rotate the applied voltage, so that its direction relative to the stator 106 rotates, at the required rate of rotation of the motor. Assuming that the voltage is high enough to maintain rotation of the rotor 104, the rotor will continually align itself with the rotating voltage, and the rotor will thus rotate at the required speed. When the motor is to be started from rest, either on startup or when recovering from a stall, the motor can be started from zero speed in this mode, by starting the voltage in an arbitrary direction. As the speed of the motor increases the control unit 42 is arranged to switch from this low speed control mode to the high speed sensorless control mode at a predetermined speed, typically around 10 or 20% of the base speed of the motor. As is well known, the base speed of the motor is the speed at which the magnitude of the back-emf is equal to the maximum voltage that can be applied to the windings from the ECU.

The advantage of using a predictor/compensator type of sensorless algorithm is that it compensates for a number of variable parameters that could otherwise affect the accuracy of the position estimation. Some of the parameters used in the algorithm equations will vary from one motor to another. These include, for example, motor phase resistance R, motor inductance L, motor mechanical viscosity B, motor mechanical inertia J, and the motor back emf and torque constants Kₑ and kₜ. If a predictor/compensator system were not used, then these parameters could be measured for each motor as it is produced and input individually into the sensorless algorithm. However, this is obviously time consuming and inconvenient. Some of the parameters will also vary with temperature, such as R, L and B. Again, if the predictor/compensator model were not used, then the temperature could be monitored and the equations of the algorithm modified to take the temperature into account. However, this makes the model significantly more complicated which increases the computational overheads.

While the embodiment described above uses a non-linear observer, other closed loop observers such as a Luenberger observer or a Kalman filter can be used.

For reference, a system in which a motor position sensor is used instead of the position determining algorithm is shown in FIG. 9.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A power steering system comprising a hydraulic circuit, a pump arranged to pressurize hydraulic fluid and valve means arranged to control the flow of pressurized fluid in the hydraulic circuit to control the steering force provided by the system, the system further comprising a motor arranged to drive the pump and control means arranged to control operation of the motor, wherein the control means is arranged to determine the position of the motor from a plurality of parameters by means of a position determining algorithm.

2. A system according to claim 1 wherein the position determining algorithm defines a model of the motor which is arranged to estimate the motor position from at least one model input.

3. A system according to claim 2 wherein the position determining algorithm includes an observer arranged to monitor an output of the model and compare it to a measured parameter thereby to determine a correction factor that can be input to the model.

4. A system according to claim 3 wherein the observer is a non-linear observer.

5. A system according to any foregoing claim wherein the control means is arranged to produce an indicator of the motor position determined by the algorithm, and to determine the rotational speed of the motor from the indicator.

6. A system according to claim 5 wherein the control means is arranged to differentiate the indicator to determine the rotational speed of the motor.

7. A system according to any foregoing claim wherein the control means includes a DC link to which a DC link voltage is applied, and a drive stage arranged to connect the DC link to windings of the motor to control the motor, and the control means is arranged to determine an electrical parameter of the windings from an electrical parameter of the DC link.

8. A system according to claim 7 wherein the electrical parameter is voltage.

9. A system according to claim 8 wherein the drive stage is arranged to connect the windings to the DC link using pulse width modulation control, and to determine the phase voltages from the DC link voltage and duty cycles of the PWM control.

10. A system according to claim 7 wherein the parameter is electric current.

11. A system according to claim 10 wherein the drive stage is arranged to open and close connections between each of the windings and the DC link, and to measure the current in one of the windings by measuring the current in the DC link at the times when that winding is connected to the DC link.

12. A system according to any foregoing claim wherein the control means is arranged, at low motor speeds, to switch to a low speed open loop position control mode in which the voltage in the motor is rotated to rotate the magnetic field in the motor at the rotational speed that is required of the motor.

13. A system according to any foregoing claim wherein the control means is arranged to receive inputs indicative of a vehicle parameter relating to operation of a vehicle, to determine a desired motor speed dependent on the vehicle parameter, and to control the speed of the motor to the desired motor speed.

14. A system according to claim 13 wherein the vehicle parameter is vehicle speed or steering rate.

15. A controller for a motor for a power steering system, the controller being arranged to determine the position of the motor from a plurality of parameters by means of a position determining algorithm.

16. A power steering system substantially as hereinbefore described with reference to any one or more of the accompanying drawings.

17. A controller for a motor for a power steering system substantially as hereinbefore described with reference to any one or more of the accompanying drawings.
